(19) United States
(12) Patent Application Publication
(10) Pub. No.: US 2009/0266931 A1
(43) Pub. Date: Oct. 29, 2009

(54) ROLLING DOOR ASSEMBLY AND RELATED METHODS

(76) Inventor: Greg Gottschalk, Orlando, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/429,648

(22) Filed: Apr. 24, 2009

Related U.S. Application Data
(60) Provisional application No. 61/047,617, filed on Apr. 24, 2008.

(51) Int. Cl. F16C 3/02; B65H 75/18; E06B 9/68; B21D 3/00

(52) U.S. Cl. 242/599; 464/182; 72/367.1

(57) ABSTRACT

A rolling door assembly includes an axle assembly having an axle extending through a tube to which the door curtain is attached. A plurality of drums extends between the tube and the axle. The cost and weight of the axle assembly can be significantly reduced forming the drums from stamped sheet metal, as well as using relatively thin roll-formed and butt-welded sheet metal to the form the tube. An axle assembly can also include a spiral wound tube that can be readily unwound and replaced with minimal disassembly of the rest of the door assembly.

### CROSS-REFERENCE TO RELATED APPLICATION

This application claims the benefit of U.S. Provisional Application No. 61/047,617, filed on Apr. 24, 2008, the contents of which are hereby incorporated by reference in their entirety.

### FIELD OF THE INVENTION

The present invention relates to rolling door assemblies and, more particularly, to axle assemblies for rolling doors.

### BACKGROUND OF THE INVENTION

Rolling doors are frequently used in warehouses, industrial and commercial buildings, and other settings. Despite the prevalence of such doors, many of the parts required are specialized, purpose-built parts that can be difficult and expensive to acquire.

Also, in many rolling door applications, a heavier-duty door is desired or required. For example, a curtain door formed from a plurality of adjoined slats is often employed as a heavy-duty door. Current rolling door designs call for heavy, bulky support systems, such as very heavy axle assemblies, for use in connection with such heavy-duty doors.

### SUMMARY OF THE INVENTION

Based on the foregoing, it is an object of the present invention to provide a rolling door assembly that allows the use of more standardized parts, and reduces the weight and complexity of components needed to support the doors.

According to an embodiment of the present invention, an axle assembly for a rolling door includes an axle, a tube arranged around the axle and adapted for securing a rolling door thereto, and a plurality of stamped sheet metal drums extending between the axle and the tube.

According to an aspect of the present invention, the tube is formed from roll-formed and butt-welded sheet metal, preferably less than approximately 0.1 inch thick.

According to a method aspect, a method of making an axle assembly for a rolling door includes roll-forming sheet metal to form a tube, stamping a plurality of sheet metal drums, and arranging the tube and the plurality of sheet metal drums around an axle, such that the drums extend between the axle and the tube.

According to another embodiment of the present invention, an axle assembly for a rolling door includes an axle, a spiral-wound metal tube arranged around the axle and adapted for securing a rolling door thereto, and a plurality of drums extending between the axle and the tube.

According to another method aspect, a method of making a rolling door assembly includes spiral winding a tube, connecting the tube to a plurality of drums arranged about an axle, and connecting a curtain to the tube.

According to further aspects of the present invention, the tube is spiral wound around the axle and drums and the method includes preliminary steps of detaching the curtain from a previous spiral wound tube, and removing the previous tube by detaching the previous tube from the drums and unwinding the previous tube.

These and other objects, aspects and advantages of the present invention will be better appreciated in view of the drawings and following description of preferred embodiments.

### BRIEF DESCRIPTION OF THE DRAWINGS

FIG. 1 is an exploded, perspective view, with components partially cut-away to show details, of a rolling door assembly with an axle assembly, according to an embodiment of the present invention;

FIG. 2 is a sectional view of the axle assembly of FIG. 1; and

FIG. 3 is an exploded, perspective view, with components partially cut-away to show details, of a rolling door assembly, according to another embodiment of the present invention.

### DETAILED DESCRIPTION OF PREFERRED EMBODIMENTS

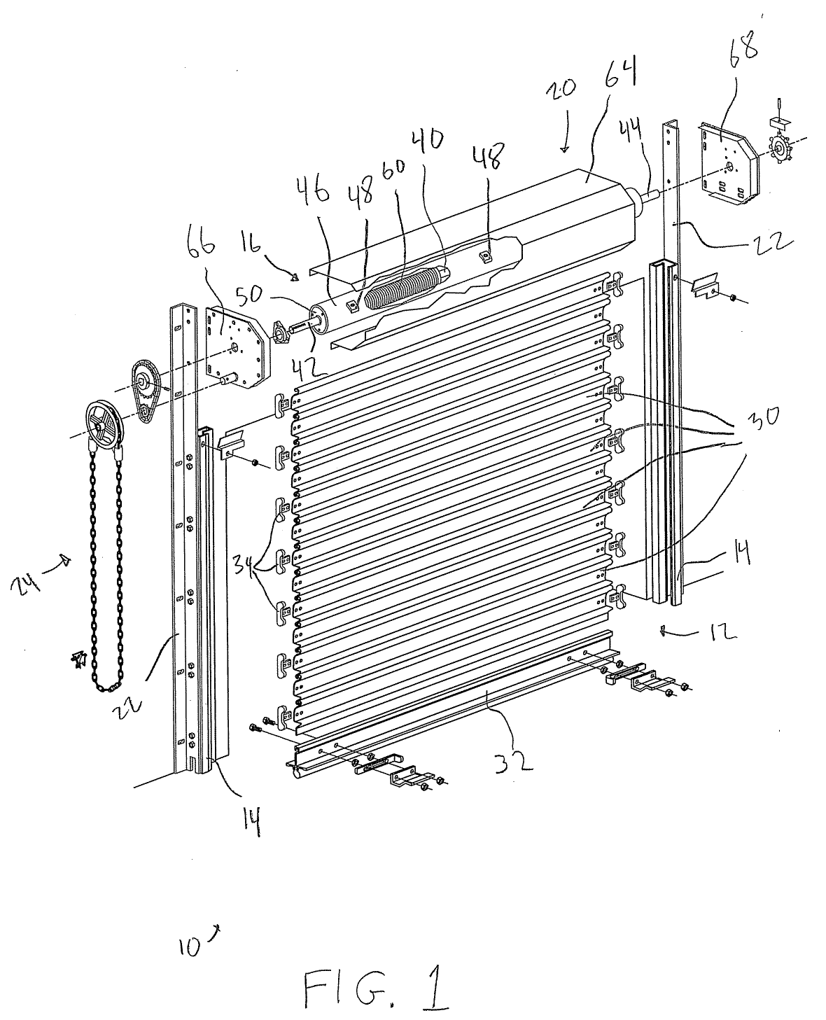

Referring to FIG. 1, according to an embodiment of the present invention, a rolling door assembly 10 includes a curtain 12 extending between opposed rails 14. The rolling door assembly 10 further includes an axle assembly 16 arranged within a housing 20 extending between mounting angles 22. A drive mechanism 24, such as a chain hoist, engages one side of the axle assembly 16.

The curtain 12 includes a plurality of interlocking slats 30 and a bottom bar 32. The curtain 12 further includes a plurality of endlocks 34 attached to the slats 30. The endlocks 34 are slidable within the rails 14 during raising and lowering of the curtain 12.

The axle assembly 16 includes a split axle 40 having first and second portions 42, 44 coaxially extending from opposite ends of a tube 46. The tube 46 is advantageously made by roll-forming and butt-welding sheet metal. The thickness of the sheet metal is preferably such that the wall thickness of the resulting tube is less than the schedule 10 thickness for an equivalent-diameter pipe, or less than about 0.1 inch. Attachment blocks 48 are welded to the tube 46. The top of the curtain 12 is secured to the attachment blocks by, for instance, bolting, such that rotation of the tube 46 is effective to raise or lower the curtain 12.

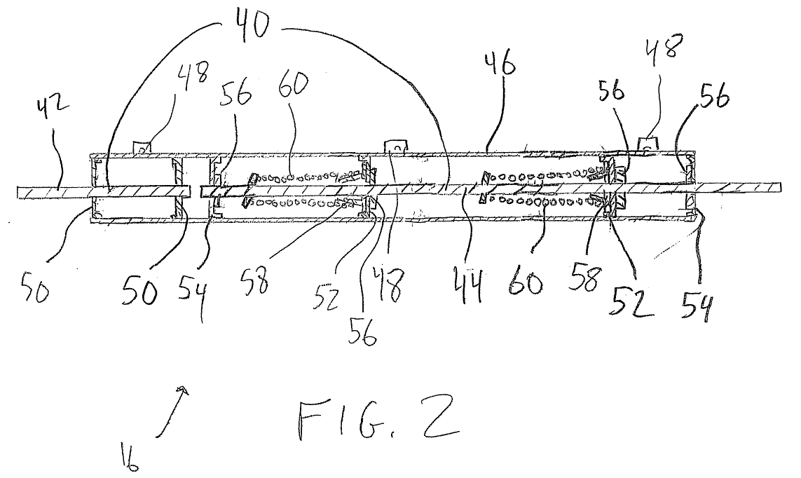

Referring to FIG. 2, the axle assembly 16 additionally includes drums 50, 52, 54 extending between the tube 46 and the axle 40. The drums 50, 52, 54 are advantageously formed from stamped sheet metal. The drums 50 are attached to both the tube 46 and the axle 40, allowing rotational motion imparted to the first portion 42 by the drive mechanism 24 to be transmitted to the tube 46. The drums 52, 54 are attached to the tube 46 and free rotate relative to the second portion 44 of the axle, for example, using bearings 56.

Spring cones 58 are connected to the drums 52. The spring cones 58 connect respective ends of counter-balance springs 60 to the drums 52. The other ends of the counter-balance springs 60 are attached to the second portion 44 of the axle 40. The counter-balance springs 60 are configured to counter-balance the weight of the curtain 12, facilitating raising of the curtain 12, as well as retention of the curtain 12 in partially and fully raised positions, as will be appreciated by those skilled in the art.

Referring again to FIG. 1, the housing 20 includes a hood 64 and opposing head plates 66, 68 attached to respective angles 22. The tube 46 of the axle assembly 16 is arranged within the housing 20, such that when the curtain 12 is raised, the curtain 12 rolls up around the tube 46 into the housing 20. The first and second portions 42, 44 extend through respective head plates 66, 68. The driving mechanism 24 is mounted to the head plate 66 and engages the first portion 42 of the axle 40.

It will be appreciated that a rolling door assembly according to the foregoing embodiment eliminates the need for a tube formed from a thicker and heavier, and consequently more expensive, pipe material, for instance, the industry standard schedule 40, while still allowing secure attachment of the curtain 12 with attachment blocks 48. Additionally, the stamped steel drums 50, 52, 54 allow for ready integration of commercially available spring cones, bearings and the like into the axle assembly 20, further reducing manufacturing time and costs.

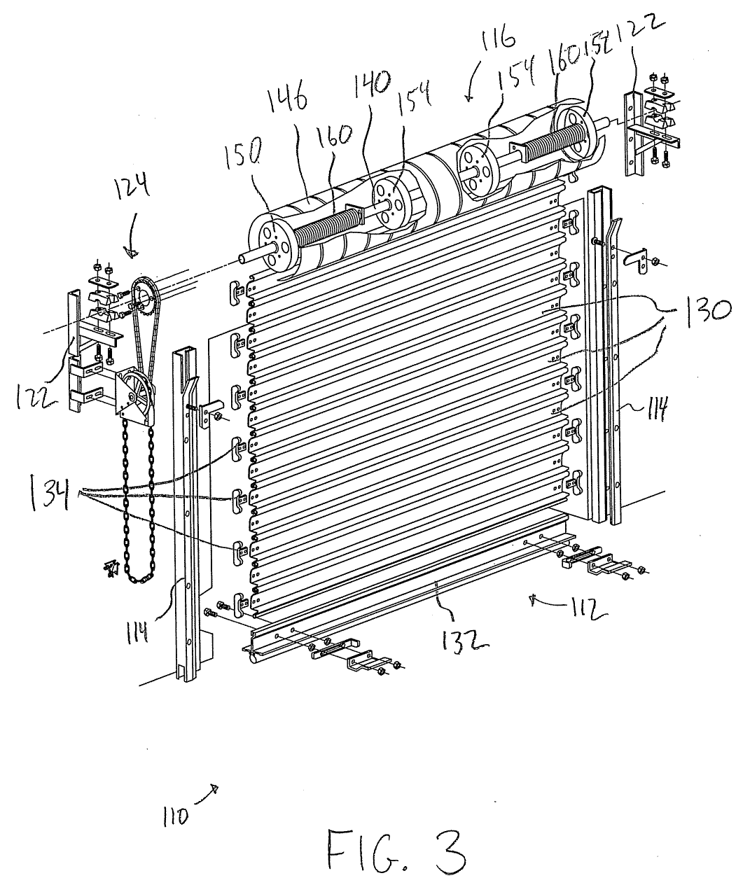

Referring to FIG. 3, according to another embodiment of the present invention, a rolling door assembly 110 includes a curtain 112 extending between opposed rails 114. The rolling door assembly 110 further includes an axle assembly 116 extending between mounting brackets 122. A drive mechanism 124, such as a chain hoist, engages one side of the axle assembly 116.

The curtain 112 includes a plurality of interlocking slats 130 and a bottom bar 132. The curtain 112 further includes a plurality of endlocks 134 attached to the slats 130. The endlocks 134 are slidable within the rails 114 during raising and lowering of the curtain 112.

The axle assembly 116 includes a single axle 140 that is unrotatably secured to the brackets 122. A spiral wound tube 146 is arranged around the axle 140. The curtain 112 is connected directly to the tube 146. Drums 150, 152, 154 extend between the axle 140 and the tube 146. The drums 150, 152, 154 are connected to the tube 146 and rotatable relative to the axle 140.

The driving mechanism 124 engages the drum 150 allowing rotational motion to be imparted to the tube 146 to raise or lower the curtain 112. Counter-balance springs 160 extend between the drums 150, 152 and the axle 140 to offset the weight of the curtain 112.

It will be appreciated that a rolling door assembly according to the foregoing embodiment, by employing a spiral wound tube 146, allows for easier in place replacement of the tube 146 and other components of the axle assembly 116. For instance, the curtain 112 can be completely lowered and detached from the tube 146. The axle assembly 116 can then be unwound, removed, and replaced with another assembly. Components internal to the tube 146 can also be readily replaced with the tube 146 removed.

The present invention is not necessarily limited to the embodiments described herein. Rather, those skilled in the art will appreciate that numerous modifications, and adaptations to particular circumstances, can be made within the scope of the present invention.

For instance, the present invention is not necessarily limited to a certain type of rolling door, such as the curtain doors shown herein, although features of the present invention are particularly advantageous in connection therewith. Additionally, the present invention is not necessarily limited to a particular type or configuration of curtain, axle assembly, rails, brackets or driving mechanisms. For example, windlocks could be used in lieu of, or in addition to, the endlocks shown. Also, other designs of slats, including insulated slats, could be employed.

The foregoing is not an exclusive list of modifications or adaptations. Rather, those skilled in the art will understand that these and other modifications and adaptations are possible within the scope of the invention as herein shown and described and of the claims appended hereto.

What is claimed is:

1. An axle assembly for a rolling door, the assembly comprising:
an axle;
a tube arranged around the axle and adapted for securing a rolling door thereto;
a plurality of stamped sheet metal drums extending between the axle and the tube.

2. The assembly of claim 1, wherein the axle is a split axle having first and second axle portions, a first one of the drums extending between the first axle portion and the tube and a second one of the drums extending between the second axle portion and the tube.

3. The assembly of claim 2, wherein the first one of the drums is connected to the first axle portion and to the tube and the second one of the drums is connected to the tube and freely rotatable about the second axle portion.

4. The assembly of claim 3, further comprising a counter-balance spring extending between the second axle portion and the second one of the drums.

5. The assembly of claim 4, wherein the counter-balance spring is connected to the second axle portion and to the second one of the drums.

6. The assembly of claim 5, wherein the counter-balance spring is connected to the second one of the drums by a spring cone.

7. The assembly of claim 1, wherein the tube is sheet metal.

8. The assembly of claim 7, wherein the tube is roll-formed and butt-welded.

9. The assembly of claim 7, wherein the sheet metal is less than approximately 0.1 inch thick.

10. A method of making an axle assembly for a rolling door, the method comprising:
roll-forming sheet metal to form a tube;
stamping a plurality of sheet metal drums; and
arranging the tube and the plurality of sheet metal drums around an axle, such that the drums extend between the axle and the tube.

11. The method of 10, further comprising butt-welding abutting edges of the roll-formed tube.

12. The method of 10, further comprising connecting the sheet metal drums to the tube.

13. The method of 12, further comprising connecting at least one of the sheet metal drums with a portion of the axle.

14. An axle assembly for a rolling door, the assembly comprising:
an axle;
a spiral-wound metal tube arranged around the axle and adapted for securing a rolling door thereto; and
a plurality of drums extending between the axle and the tube.

15. The assembly of claim 14, wherein the axle is a solid axle.

16. The assembly of claim 14, wherein the tube is freely rotatable about the axle.

17. The assembly of claim 16, wherein the plurality of drums are connected to the tube and freely rotatable about the axle.

18. A method of making a rolling door assembly, the method comprising:
spiral winding a tube;
connecting the tube to a plurality of drums arranged about an axle; and
connecting a curtain to the tube.

19. The method of claim 18, wherein the tube is spiral wound around the axle and drums.

20. The method of claim 19, further comprising preliminary steps of:
detaching the curtain from a previous spiral wound tube; and
removing the previous tube by detaching the previous tube from the drums and unwinding the previous tube.
